(19) United States
(12) Patent Application Publication
(10) Pub. No.: US 2021/0222992 A1
(43) Pub. Date: Jul. 22, 2021

(54) DEVICE FOR AVERTING DANGER

(71) Applicant: Frank Zastrow, Heidelberg (DE)

(72) Inventor: Frank Zastrow, Heidelberg (DE)

(21) Appl. No.: 17/058,899

(22) PCT Filed: May 6, 2019
(86) PCT No.: PCT/DE2019/200037

§ 371 Date: Nov. 25, 2020

(30) Foreign Application Priority Data
May 28, 2018 (DE) 10 2018 208 346.0
Jul. 10, 2018 (DE) 10 2018 211 418.8

(51) Int. Cl. F41B 15/02; H04M 1/21; H04B 1/3888; A45C 11/00; A45C 15/00

(52) U.S. Cl. CPC F41B 15/02; H04M 1/21; A45C 2011/002; A45C 11/00; A45C 15/00; H04B 1/3888

(57) ABSTRACT

A device for averting danger includes a base body for attachment to a mobile communication device, wherein the base body surrounds the mobile communication device at least in regions, and wherein at least one active element is arranged on the base body and projects from the base body in such a way that the active element can be used as an impact amplifier.

The invention relates to a device for averting danger.

Devices for averting danger, in particular for self-defense, are already sufficiently known from practice. This can be, for example, a defensive spray. Corresponding systems comprise an irritant gas or gel which is located in a spray can and which in a dangerous situation can be sprayed into the face of an animal or attacker in order to render them incapable of attacking. Similar means can be fired off with a so-called alarm pistol or gas pistol.

Furthermore, electroshock weapons have already been used for averting danger for many years. They serve to give an attacker an electric shock of high voltage but low current and to thus incapacitate them. Electroshock weapons can take the form of a handheld device, a rod device, or a pistol (TASER).

Furthermore, different devices which bring about shock amplification exist. In the simplest case, these can be a stick or telescopic stick. Another object which can be used as a impact amplifier and is found in a wide variety of martial arts is the kubotan. This is a short stick or rod, which usually takes the form of a key chain and serves as a shock or pressure amplifier. It is also known to design the kubotan as a writing utensil. Such objects are referred to as tactical pens. The kubotan is usually somewhat larger than the closed fist of the user so that the ends of the kubotan project from the closed fist. A correspondingly trained fighter can effectively ward off an attacker by hitting joints, nerves, pressure points, etc. with the ends of the kubotan in a targeted manner.

One problem that all of the devices for averting danger described above have is that they are extremely difficult to carry along in everyday life. It is thus not ensured that the device is always being carried on the user's person so that the device is not always within reach in a dangerous situation.

The object of the present invention is therefore to design and develop a device for averting danger in such a way that it is as comfortable and easy to carry as possible.

According to the invention, the aforementioned object is achieved by the features of claim 1. This claims a device for averting danger, comprising a base body for attachment to a mobile communication device, wherein the base body surrounds the mobile communication device at least in regions thereof and wherein at least one active element is arranged on the base body and projects from the base body in such a way that the active element can be used as a impact amplifier.

In the manner according to the invention, it was first realized that the underlying object can be achieved in a surprisingly simple manner by the device being arrangable on a mobile communication device, in particular a mobile telephone, smartphone, etc. Since mobile communication devices, in particular mobile telephones, smartphones, etc., are nowadays carried at all times by the vast majority of people, it is ensured in a surprisingly simple manner that the device according to the invention can be conveniently carried along in everyday life. The risk of the device not being available in a dangerous situation is thus minimized.

In a further manner according to the invention, a base body which can be attached to the mobile communication device and surrounds it at least in regions is provided for this purpose. In order to enable the user to avert danger effectively or defend themselves, the at least one active element projects from the base body in such a way that it can be used as a impact amplifier. The active element can be understood in this respect as a kubotan tip. The device thus makes it possible in a simple manner to use the mobile communication device in the sense of a kubotan. The active element could project from the base body by 0.5 cm to 4.5 cm, for example 1 cm to 4 cm, in particular 1.5 cm to 3.5 cm, preferably 2 cm to 3 cm, in order to be ideally usable as a impact amplifier.

At this point, it is again pointed out that the mobile communication device can be, for example, a mobile telephone or a smartphone. The base body could thus be realized in the broadest sense as a sleeve or case for a mobile telephone or smartphone, wherein at least one active element thereon can be used as a impact amplifier. A device similar to the kubotan is thus created and can be used to effectively avert danger or defend oneself. It is also essential that the active element is not necessarily directly connected to the base body. Instead, the active element can be operatively connected to the base body indirectly, via further components.

According to an advantageous development, the device could have a cover which is foldably connected to the base body via a fold so that, for example, a display of the mobile communication device is protected by the cover, namely when the latter is folded onto the display. In such a development, the active element or the active elements could be arranged in the fold and could be pushed out along the longitudinal side of the fold, for example by means of sliders, and could optionally be locked. It is also possible for the active element and/or the active elements to be folded out of the fold when the cover is folded open and to be lockable in this position. Alternatively or additionally, the device could be reinforced in the region of the fold, for example by a metal insert. In this case, the device could consist at least partially of leather, artificial leather, or a similar material. A mirror that serves, for example, as a make-up mirror could be arranged on the inside of the cover. Alternatively or additionally, a receptacle for a lipstick could be formed on or in the cover. In another advantageous manner, the cover could have, on its inside, pockets for cards, in particular cash cards or credit cards. In order to prevent third parties from reading the cards, the cover could have a material that shields against electromagnetic waves, for example metal.

The base body can advantageously be designed as a frame and/or at least surround the corners of the mobile communication device. The frame can, for example, surround the longitudinal sides and the transverse sides of the communication device. It is essential that the base body be securely connected to the mobile communication device, even when the active element is used as a impact amplifier and is thus subject to a high load. If the base body is designed as a frame, the regions extending along the longitudinal sides of the device could be design as a grip area. The grip area could have a grip-enhancing surface, for example be provided with a rubber coating, corrugations, etc.

It is furthermore conceivable for the base body and/or the active element or the active elements to consist of a material which is as sturdy as possible and at the same time light, for example a plastic or of a metal. In order to conveniently carry and mask the device, at least the active elements could have a coating of a soft material, for example a plastic. Masking is realized optically by the coating, wherein the shock effect of the active elements should not be restricted or at most slightly restricted.

In a particularly advantageous manner, the size of the base body could be adaptable to the size of the mobile communication device. For this purpose, the base body can, for example, be designed as a parallel-walled frame which surrounds the longitudinal sides and the transverse sides of the communication device. Alternatively, the base body could be designed as a cruciform frame for this purpose, i.e., extend diagonally over the rear side of the communication device from opposite corners and optionally be customizable by means of lag screws to the corresponding dimensions. In such a construction, the active element or the active elements could be placed on the lag screws. It is also conceivable for the base body to have at least one fastening means which consists of at least two fastening elements that can be displaced in relation to each other and can be fastened to each other. These could extend over the rear side of the mobile communication device and with their free end at least partially encompass the communication device. At least one active element could be arranged indirectly or directly on the fastening means. Alternatively, the base body can be fixedly adapted to the dimensioning of the mobile communication device in question.

In order to enable a plurality of self-defense techniques, it is conceivable that two active elements be arranged on the base body and extend in the longitudinal direction away from the base body. In another advantageous manner, it is conceivable for the active elements to each extend centrally or on the longitudinal axis away from the base body.

According to an alternative development, it is conceivable for four active elements to be arranged on the base body, each extending away from a corner of the base body. The active elements could project diagonally or longitudinally from the base body.

In general, the active elements could be arranged on the rear side and/or on the longitudinal side and/or on the transverse side of the mobile communication device.

According to an advantageous embodiment, the active element and/or the active elements could be formed integrally with the base body. A particularly stable construction can thereby be realized.

Alternatively, it is conceivable for the active element and/or the active elements to be detachably connectible to the base body or to a region, in particular a fold, connected to the base body. It is thus possible to remove the active elements from the base body or the mobile communication device, for example to screw or pull them off. In a corresponding development, at least the base body could remain on the mobile communication device and serve as a conventional protective cover, for example in “book form.” This makes it possible to considerably simplify the handling and carrying of the device. In such a development, the active elements could take the form of key chains. In addition, it is conceivable for the active elements to be connectible to one another via magnetic forces and/or non-positively and/or positively and then to be usable as key chains.

In another advantageous manner, the active element and/or the active elements could be rod-like, in particular with a round, oval, or angular cross-section, or flat. Alternatively or additionally, the cross-section of the active element and/or of the active elements could taper toward the free end so that a tip is realized at least substantially. Particularly effective pain stimuli can thus be generated in an attacker. At its thickest point, the diameter of the active element or of the active elements could be, for example, 0.25 cm to 2.25 cm, preferably 0.5 cm to 2 cm, in particular 1 cm.

According to a further advantageous development, it is conceivable for the active element and/or the active elements to be displaceably arranged on the base body. In everyday life, for example, the active elements can thus be carried inserted into the base body so that no bothersome tips project from the mobile communication device. In a dangerous situation, the active element or the active elements can be pushed out beyond the edge region of the base body and thus of the mobile communication device and optionally be locked so that the device can be used for averting danger.

In order to also be able to use the device for opening crown corks or similar closures of containers, in particular bottles, the active element or the active elements could be slotted at their free end.

In order to further improve the ergonomics of the device, the active elements could be of two-part design. The parts of the active elements could be arranged on the base body positively and/or non-positively or via magnetic forces and be joined together in a positive and/or non-positive manner or via magnetic forces along the longitudinal axis of the active element.

In another advantageous manner, a handle, for example a tab, into which the hand of the user can engage could be formed on the base body. As a result, the device can be firmly gripped by persons with relatively small hands. The device can thus also be reliably used when more powerful external forces occur. The handle could be provided on the longitudinal side or the rear side of the base body.

There are various options for advantageously designing and developing the teaching of the present invention. To this end, reference is made, on the one hand, to the claims referring back to claim 1 and, on the other hand, to the subsequent explanation of preferred exemplary embodiments of the invention based on the drawing. In connection with the explanation of the preferred exemplary embodiments of the invention based on the drawing, generally preferred developments and further developments of the teaching are also explained. The drawing shows the following:

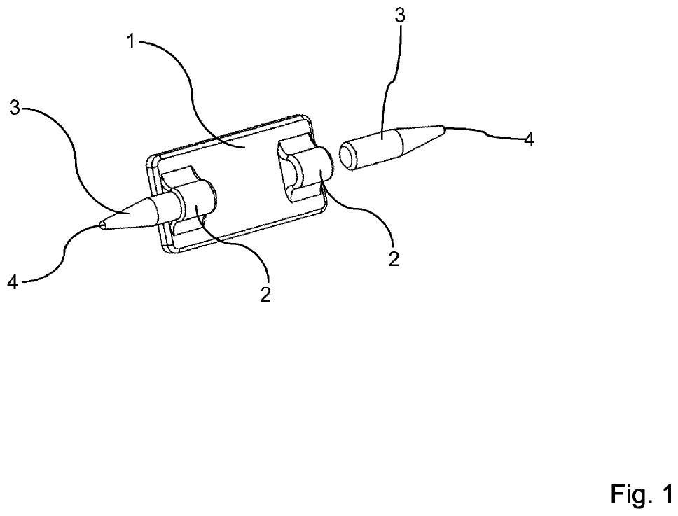

FIG. 1 a schematic, perspective view of an exemplary embodiment of a device according to the invention,

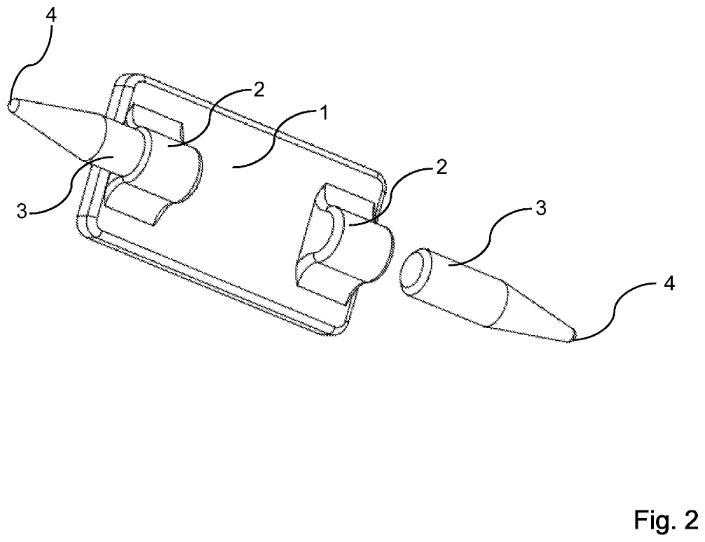

FIG. 2 another perspective view of the exemplary embodiment according to FIG. 1,

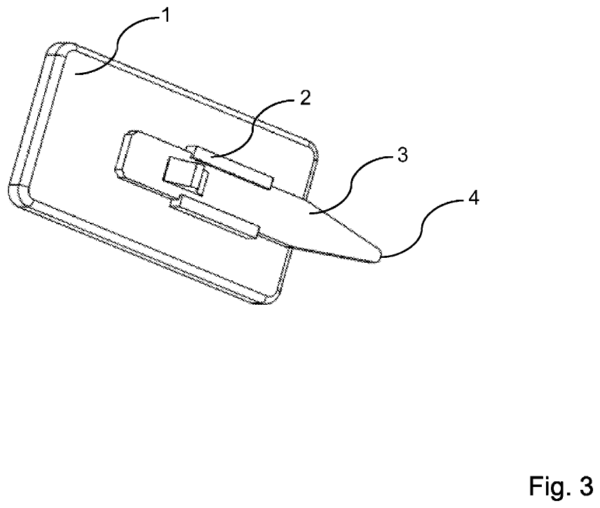

FIG. 3 a schematic, perspective view of another exemplary embodiment of a device according to the invention,

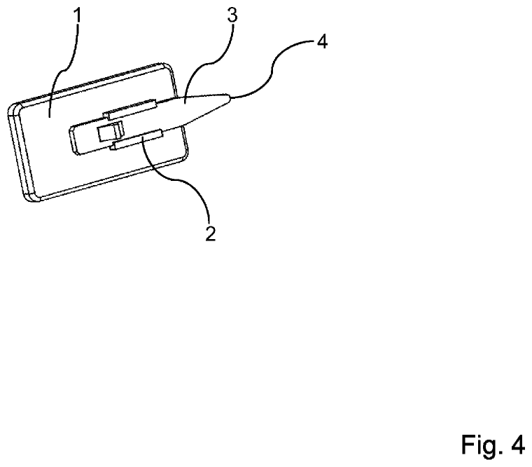

FIG. 4 another perspective view of the exemplary embodiment according to FIG. 3,

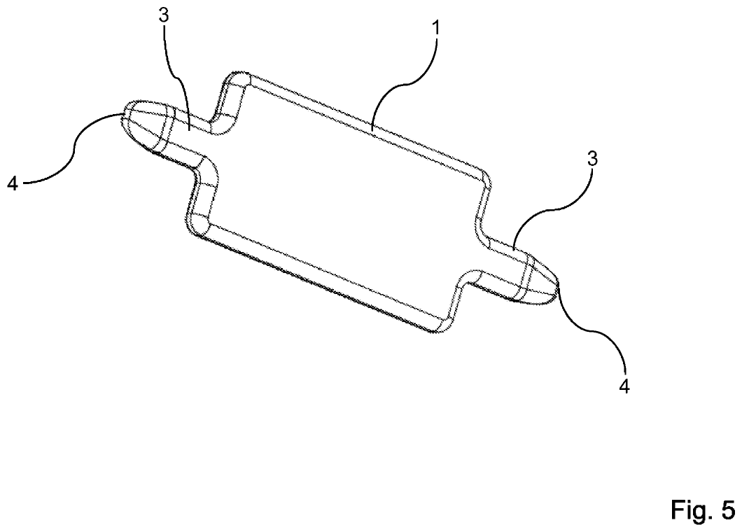

FIG. 5 a schematic, perspective view of another exemplary embodiment of a device according to the invention,

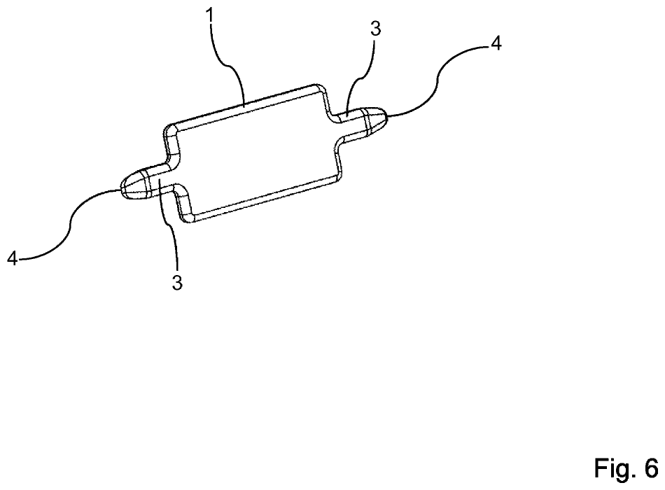

FIG. 6 another perspective view of the exemplary embodiment according to FIG. 5,

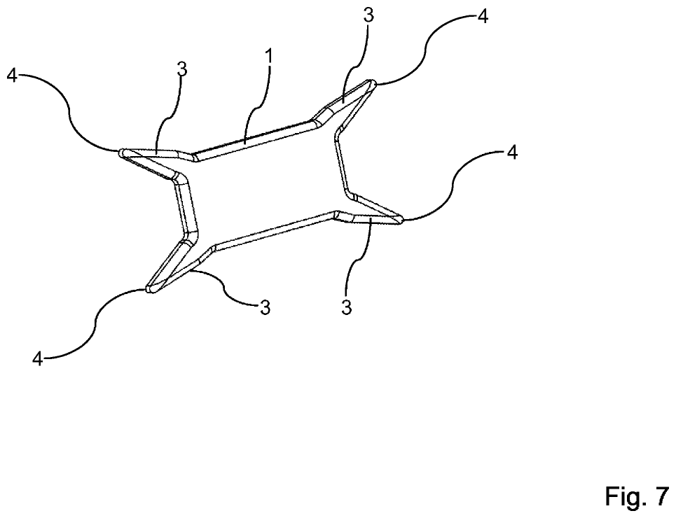

FIG. 7 a schematic, perspective view of another exemplary embodiment of a device according to the invention,

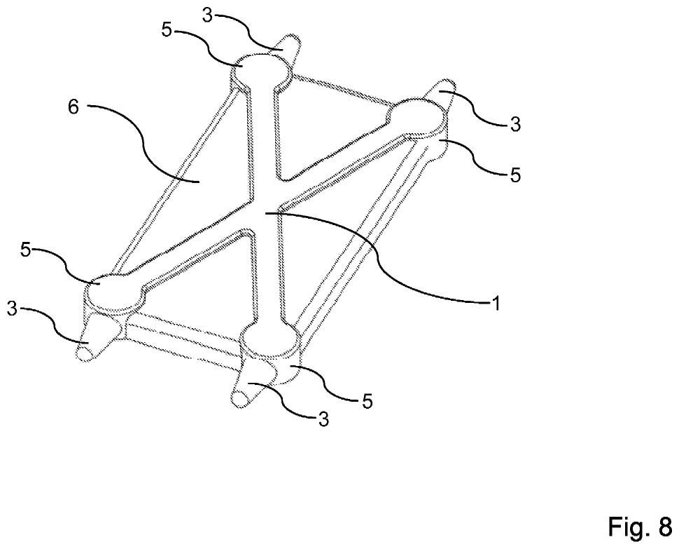

FIG. 8 a schematic, perspective view of another exemplary embodiment of a device according to the invention,

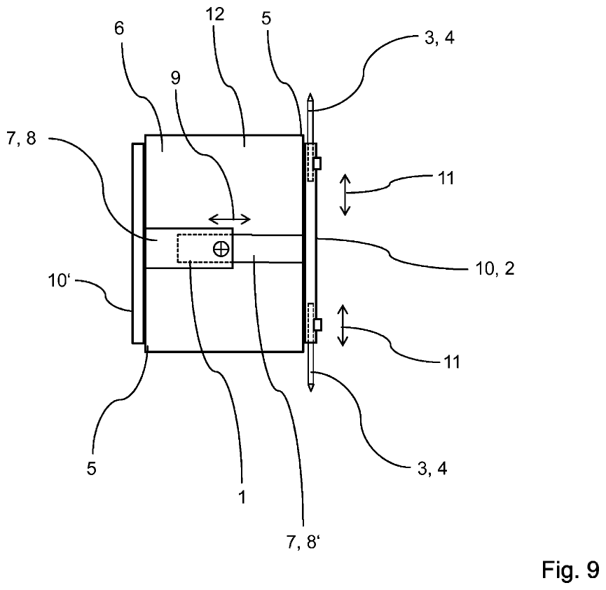

FIG. 9 a schematic view of another exemplary embodiment of a device according to the invention,

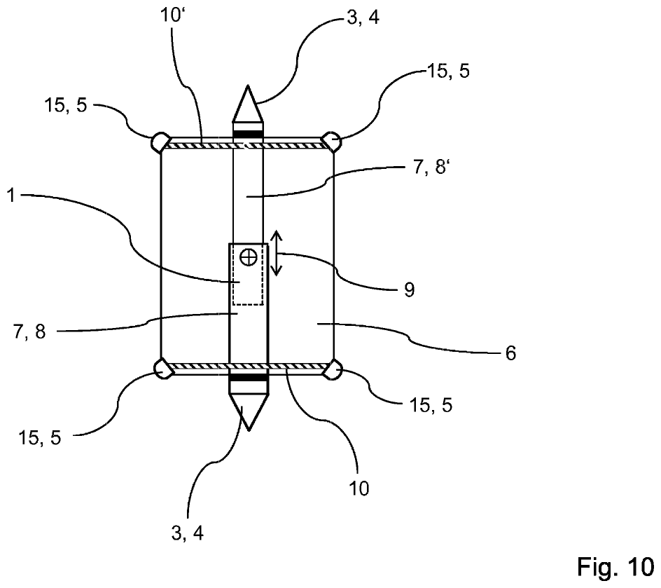

FIG. 10 a schematic view of another exemplary embodiment of a device according to the invention,

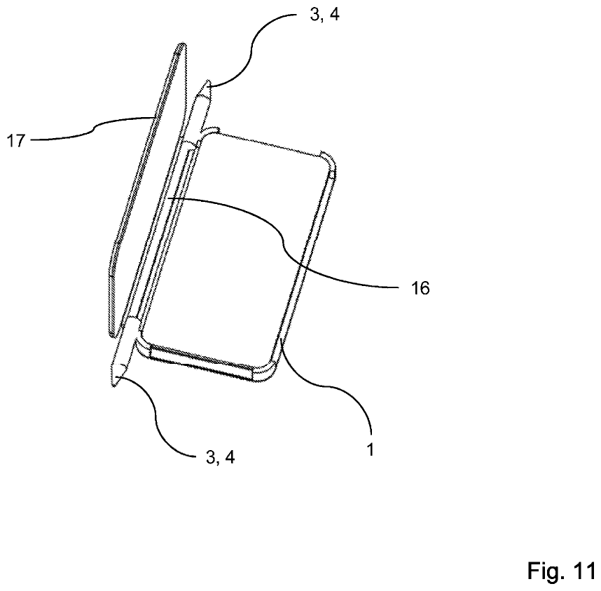

FIG. 11 a schematic view of another exemplary embodiment of a device according to the invention,

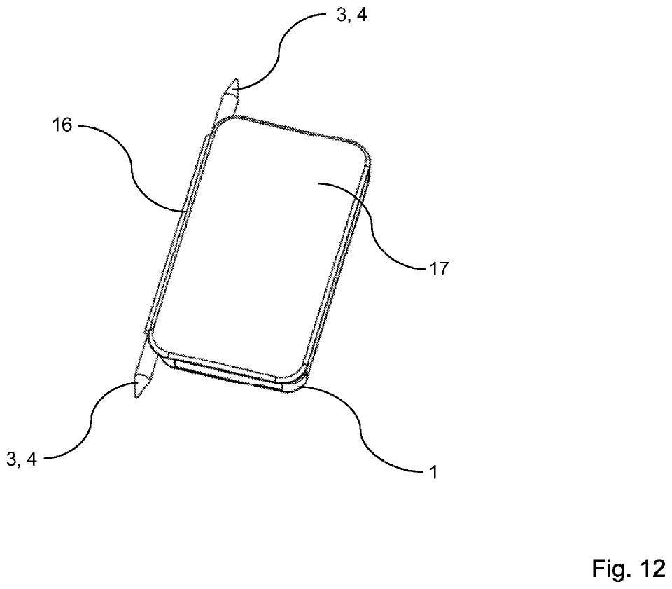

FIG. 12 another view of the exemplary embodiment according to FIG. 11, and

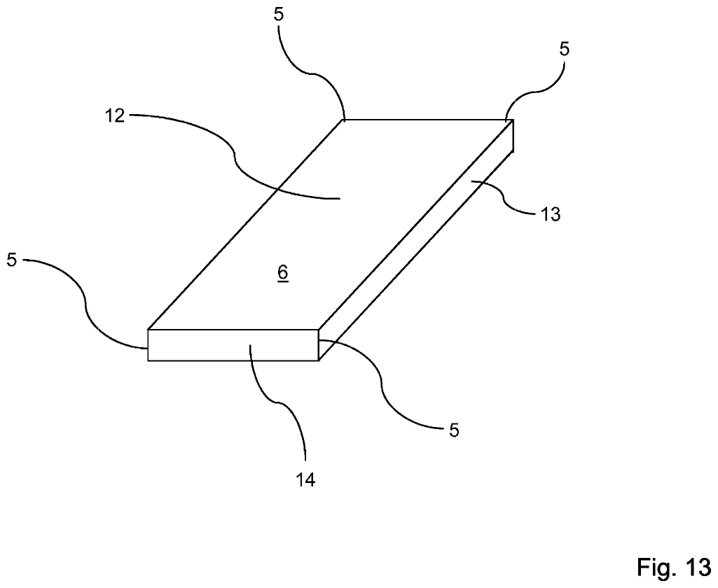

FIG. 13 a schematic view of a mobile communication device.

FIGS. 1 and 2 show different perspective views of an exemplary embodiment of a device according to the invention. The device comprises a base body 1 for attachment to a mobile communication device not shown in FIGS. 1 and 2. The base body 1 has receptacles 2 into each of which an active element 3 can be inserted. The active elements 3 thus project from the base body when viewed in the longitudinal direction thereof and can be used as impact amplifiers. In this exemplary embodiment, the active elements 3 have a round cross-section and taper toward their free end. The device according to the invention can thus be used in the sense of a kubotan to avert danger.

FIGS. 3 and 4 show another exemplary embodiment of a device according to the invention. The device comprises a base body 1 on which a receptacle 2 is formed. An active element 3 is arranged displaceably in the receptacle 2.

FIGS. 3 and 4 show the active element 3 in the pushed-out state, in which the active element 3 projects from the base body 2 when viewed in the longitudinal direction and can thus be used as a impact amplifier. The base body 1 can be attached to a mobile communication device not shown, for example a smartphone. It can also be clearly seen that the active element 3 has a flat design so that the device overall is of a flat construction and is thus convenient to carry.

In the exemplary embodiment illustrated in FIGS. 5 and 6, the device also comprises a base body 1. Active elements 3 are formed integrally or in one piece with the base body 1. The device can be attached to a mobile communication device, wherein the active elements 3 project in the longitudinal direction beyond the base body 1 and thus the mobile communication direction in such a way that they can be used as impact amplifiers like a kubotan.

In the exemplary embodiment shown in FIG. 7, the base body 1 is formed integrally with the four active elements 3. The active elements 3 extend in the diagonal direction away from the corners of the base body 1 and can be used as impact amplifiers.

In the exemplary embodiment shown in FIG. 8, the base body 1 is cruciform and encloses the corners 5 of a mobile communication device. Such an embodiment is particularly advantageous if the base body 1 is to be adaptable to the size of the mobile communication device. The active elements 3, which serve as impact amplifiers, extend from the corners 5 of the base body 1.

The exemplary embodiment of a device according to the invention shown in FIG. 9 comprises a base body 1 which is fastened to a mobile communication device 6. In this case, the base body 1 consists of a fastening means 7 which extends over the rear side 12 of the communication device 6 and consists of two fastening elements 8, 8′. The fastening elements 8, 8′ can be displaced in relation to each other or into each other along the arrow 9 and can be held in the desired position, for example be screwed together, latched, etc. A holding means 10, 10′, with which the base body 1 engages in or behind the longitudinal sides 13 of the communication device 6, is arranged on each of the fastening elements 8, 8′. The base body 1 thus consists of the fastening elements 8, 8′ and the holding means 10, 10′.

In the exemplary embodiment shown in FIG. 9, the holding means 10 serves as a receptacle 2 for the active elements 3 and forms a grip area. The active elements 3 are arranged in the holding means 10 so as to be displaceable in the direction of the arrows 11. In a dangerous situation, the user can push the active elements 3 out of the holding means 10 and optionally latch them so that the active elements 3 can be used as impact amplifiers in the sense of a kubotan.

It is pointed out that only a single active element 3 can be arranged on the holding means 10. Furthermore, one or two active elements 3 can also be provided on the further holding means 10′. Alternatively or additionally, the active elements 3 can be connected fixedly, i.e., non-displaceably, to the one or more holding means 10, 10′.

It is also possible for a plurality of fastening means 7 to be provided and/or for the fastening means 7 to extend in the shape of an x from a corner 5 of the mobile communication device 6 to the opposite corner 5. By means of the fastening means 7, it is possible to adapt the device to the dimensioning of different communication devices 6.

FIG. 10 shows another exemplary embodiment of a device according to the invention. In this case, the base body 1 is formed by a fastening means 7 and two holding means 10, 10′. The fastening means 7 has two fastening elements 8, 8′, which are displaced in relation to each other or into each other along the arrow 9 and are held in the desired position, for example screwed together, latched, etc. A holding means 10, 10′ is arranged on each of the fastening elements 8, 8′. These holding means extend transversely over the rear side 12 of the mobile communication device 6 and with their ends 15 enclose or encompass the corners 5 of the communication device 6. In this exemplary embodiment, the holding means 10, 10′ are not variable in length. However, it is conceivable that the holding means 10, 10′ are also of length-adjustable design, for example corresponding to the fastening elements 8, 8′.

Two active elements 3 are formed on the fastening means 7 and project beyond the base body 1 and the mobile communication device 6 in such a way that they can be used as impact amplifiers.

FIGS. 11 and 12 show another exemplary embodiment of a device according to the invention. The device has a base body 1 for receiving a mobile communication device not shown. Furthermore, the base body 1 is connected to a cover 17 via a fold 16. The device thus has a form similar to a book, wherein the fold 16 corresponds to a book spine and the cover 17 corresponds to a book cover.

Two active elements 3 are formed in or on the fold 16, their free ends 4 projecting from the base body in such a way that they can be used as impact amplifiers. The active elements 3 can, for example, be pushed out of the fold 16 and locked in this position. Alternatively, the active element 3 could be foldable out of the fold 16.

FIG. 13 shows a schematic, perspective view of a mobile communication device 6 and is used to define the terms used in this disclosure. FIG. 11 shows the rear side 12 of the mobile communication device 6. Furthermore, one of the longitudinal sides 13 and one of the transverse sides 14 and the corners 5 are shown.

With regard to other advantageous developments of the device according to the invention, reference is made to the general part of the description and to the appended claims in order to avoid repetitions.

Finally, it is expressly pointed out that the exemplary embodiments described above of the device according to the invention serve only to explain the claimed teaching but do not limit it to the exemplary embodiments.

### LIST OF REFERENCE NUMBERS

1 Base body
2 Receptacle
3 Active element
4 Free end
5 Corner
6 Mobile communication device
7 Fastening means
8, 8′ Fastening element
9 Arrow
10, 10′ Holding means
11 Arrow
12 Rear side
13 Longitudinal side
14 Transverse side
15 End (holding means)
16 Fold
17 Cover

1. A device for averting danger, comprising a base body for attachment to a mobile communication device, wherein the base body surrounds the mobile communication device at least in regions and wherein at least one active element is arranged on the base body and projects from the base body in such a way that the active element can be used as an impact amplifier.

2. The device according to claim 1, wherein the base body is designed as a frame and/or surrounds at least the corners of the mobile communication device.

3. The device according to claim 1, wherein the size of the base body is adaptable to the size of the mobile communication device.

4. The device according to claim 1, wherein two active elements are arranged on the base body and extend in the longitudinal direction, preferably centrally, away from the base body.

5. The device according to claim 1, wherein four active elements are arranged on the base body and each extend away from one corner of the base body, preferably diagonally or in the longitudinal direction.

6. The device according to claim 1, wherein the active element and/or the active elements are formed integrally with the base body.

7. The device according to claim 1, wherein the active element and/or the active elements can be detachably connected to the base body.

8. The device according to claim 1, wherein the active element and/or the active elements are of rod-like or flat design.

9. D device according to claim 1, wherein the cross-section of the active element and/or of the active elements tapers toward the free end.

10. The device according to claim 1, wherein the active element or the active elements are arranged so as to be displaceable on the base body.
